(19) United States
(12) Patent Application Publication
(10) Pub. No.: US 2020/0160673 A1
(43) Pub. Date: May 21, 2020

(54) NOTIFICATION METHOD, NOTIFICATION DEVICE, AND SOUND GENERATION DEVICE

(71) Applicant: DENSO CORPORATION, Kariya-city (JP)

(72) Inventor: Toshiaki NAKAYAMA, Kariya-city (JP)

(21) Appl. No.: 16/749,364

(22) Filed: Jan. 22, 2020

Related U.S. Application Data
(63) Continuation of application No. PCT/JP2018/026555, filed on Jul. 13, 2018.

(30) Foreign Application Priority Data
Jul. 25, 2017 (JP) 2017-143671

(51) Int. Cl. G08B 6/00; G10L 25/51

(52) U.S. Cl. CPC G08B 6/00; G10L 25/51

(57) ABSTRACT

The notification method is executed by a carrying device that is carried by a subject person and notifies the subject person that the carrying device is located in a predetermined target area. The notification method includes detecting a pattern sound transmitted from a sound wave transmission unit and notifying the subject person in response to the detecting of the pattern sound.

### CROSS REFERENCE TO RELATED APPLICATIONS

The present application is a continuation application of International Patent Application No. PCT/JP2018/026555 filed on Jul. 13, 2018, which designated the U.S. and claims the benefit of priority from Japanese Patent Application No. 2017-143671 filed on Jul. 25, 2017. The entire disclosures of all of the above applications are incorporated herein by reference.

### TECHNICAL FIELD

The present disclosure relates to a notification method, a notification device, and a sound generation device for detecting a sound wave and performing a notification.

### BACKGROUND

A technique for performing a notification when a carrying device carried by a subject person such as a pedestrian detects a sound output from a vehicle has been proposed.

### SUMMARY

The present disclosure provides a notification method, a notification device, and a sound generation device. The notification method is executed by a carrying device that is carried by a subject person and notifies the subject person that the carrying device is located in a predetermined target area.

### BRIEF DESCRIPTION OF DRAWINGS

The features and advantages of the present disclosure will become more apparent from the following detailed description made with reference to the accompanying drawings. In the drawings:

FIG. 1 is a block diagram showing a configuration of a notification system according to a first embodiment;

FIG. 2 is a side view showing a setting example of a notification area according to the first embodiment;

FIG. 3 is a plan view showing the setting example of the notification area according to the first embodiment;

FIG. 4 is a diagram showing an example of a waveform of a pattern sound output from a sound field generation device;

FIG. 5 is a flowchart showing a danger notification processing executed by a control unit of a carrying device;

FIG. 6 is an explanatory view showing a notification; and

FIG. 7 is a plan view showing a setting example of a notification area according to a second embodiment.

### DETAILED DESCRIPTION

A technique for performing a notification when a carrying device carried by a subject person detects a sound output from a vehicle has been proposed.

As a result of detailed examination regarding the technique, the inventor has found the following difficulty. When a notification is performed to the subject person who is in an unsafe position, the notification functions effectively. Since the notification is also performed to the subject person even in a safe position in relation to the vehicle, the notification in this case is troublesome. Moreover, when a notification is performed by an object other than a vehicle to the subject person who is in a safe position, the notification in this case is also troublesome.

The present disclosure provides a notification method that notifies a subject person in an unsafe position and reduce a notification to the subject person in a safe position.

An example embodiment of the present disclosure provides a notification method. The notification method is executed by a carrying device that is carried by a subject person and notifies the subject person that the carrying device is located in a predetermined target area.

The notification method includes detecting a pattern sound transmitted from a sound wave transmission unit. The sound wave transmission unit transmits the pattern sound that indicates a sound having a specific pattern to the target area. The notification method includes notifying the subject person in response to the detecting of the pattern sound.

In the example embodiment of the present disclosure, the notification is performed to the subject person in the target area formed by the pattern sound. Thus, when the area that is not safe is set to be the target area, the notification method can notify the subject person in the unsafe position and reduce a notification to the subject person in the safe position.

Embodiments of the present disclosure will be described below with reference to the drawings.

(1. First Embodiment)

(1-1. Configuration)

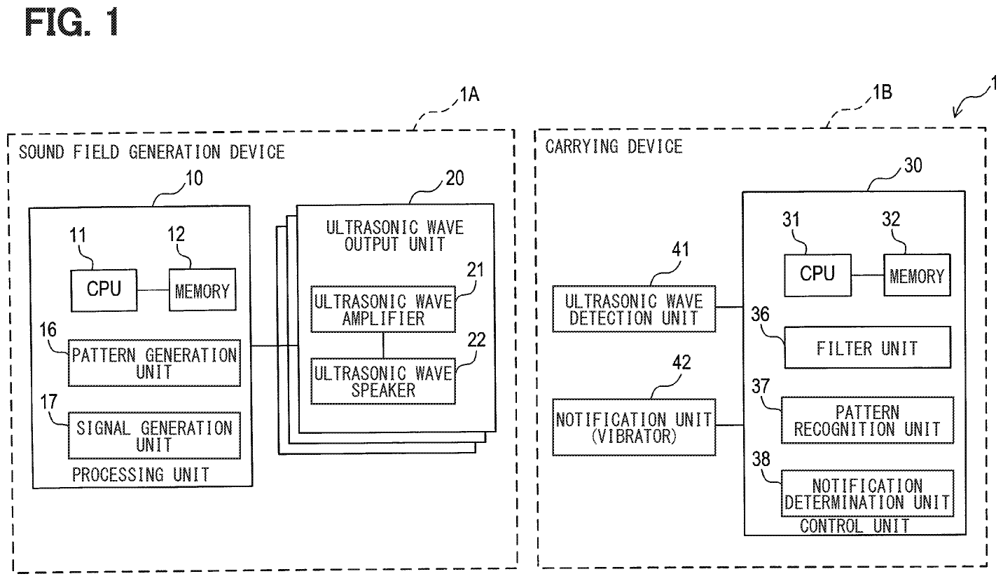

A notification system 1 shown in FIG. 1 is a system in which a carrying device 1B notifies a subject person when the carrying device 1B carried by the subject person is located in a preset target area.

Here, the subject person indicates a person to be notified. The subject person may include a general pedestrian or a visually handicapped person. In addition, the target area indicates an area that may be dangerous for the subject person, that is, an unsafe area. The target area is set within a specific direction and an angle range with respect to the sound source. For example, the target area according to the present embodiment is set at the end of a platform of the railway station. The target area is set within a predetermined angle range downward from a speaker as the sound source. The predetermined angle range may be provided by a range of 5 deg around the sound axis.

As shown in FIG. 1, the notification system 1 includes a sound field generation device 1A and the carrying device 1B.

The sound field generation device 1A is a device that is arranged outside the carrying device 1B and forms a notification area 51 that is a sound field using the ultrasonic wave. The sound field generation device 1A includes a processing unit 10 and an ultrasonic wave output unit 20. The notification area 51 is set so as to include at least a part of the target area. In the present embodiment, description will be made assuming that the notification area 51 coincides the target area.

The carrying device 1B is a device carried by the subject person. The carrying device 1B may be provided by a mobile phone, a smartphone, a wearable computer, or the like. The carrying device 1B includes a control unit 30, an ultrasonic wave detection unit 41, and a notification unit 42.

In the sound field generation device 1A, the ultrasonic wave output unit 20 includes an ultrasonic wave amplifier 21 and an ultrasonic wave speaker 22.

The ultrasonic wave amplifier 21 amplifies the waveform of the signal generated by the processing unit 10 so that the waveform has a predetermined amplification factor, and outputs the amplified waveform from the ultrasonic wave speaker 22. The ultrasonic wave amplifier 21 may be provided for each ultrasonic wave speaker 22 or may be provided for a plurality of ultrasonic wave speakers 22.

The ultrasonic wave speaker 22 is an ultrasonic wave generator that generates air vibration having a frequency higher than a human audible band, for example, 20 kHz or more. The ultrasonic wave speaker 22 may be provided by a piezoelectric speaker suitable for ultrasonic wave reproduction. The piezoelectric speaker may include a ceramic speaker, a piezo speaker, or the like.

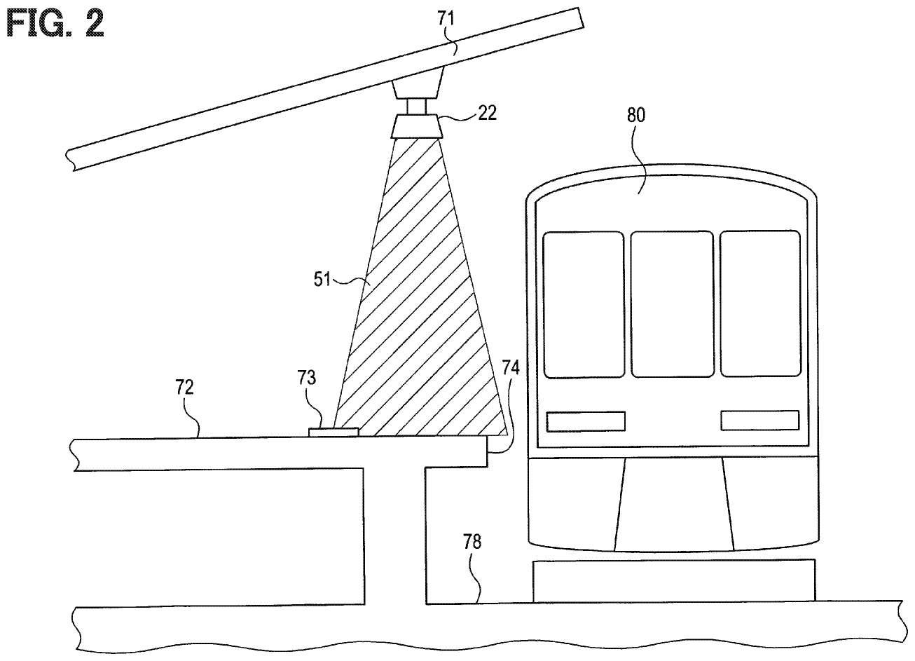

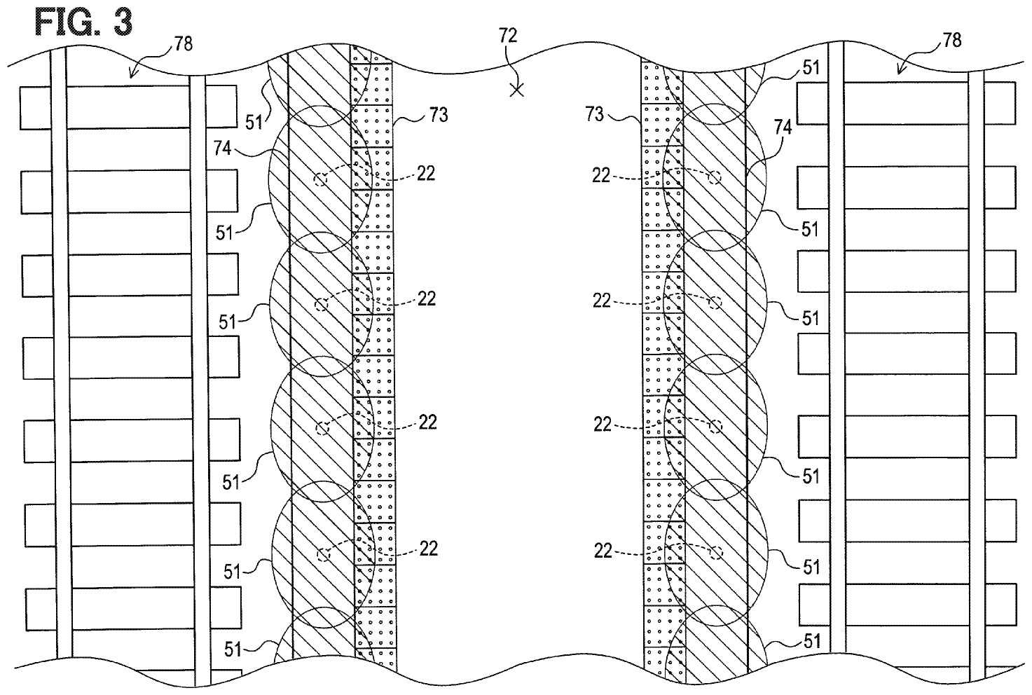

As shown in FIGS. 2 and 3, the ultrasonic wave speakers 22 are arranged along a traveling direction of the railway vehicle 80 on the ceiling 71 of the platform 72 of the railway station. An area where the sound wave from the ultrasonic wave speaker 22 are output, that is, an area where the sound wave can be detected by the carrying device 1B is referred to as the notification area 51. The notification area 51 shown in FIGS. 2 and 3 may be provided by an area having −6 dB or more with respect to the sound pressure at the center of the direction in which the sound wave is output by the ultrasonic wave speaker 22, that is, the sound pressure at the sound axis.

Each of the plurality of ultrasonic wave speakers 22 is set such that an area between a yellow line 73 such as a braille block disposed on the platform 72 and an end 74 of the platform 72 is provided as the notification area 51. The plurality of ultrasonic wave speakers 22 are disposed at approximately equal intervals so that the area between the yellow line 73 and the end 74 of the platform 72 is provided as a notification area, and the entire notification area is provided as the notification area 51. The notification area 51 provided by the plurality of ultrasonic wave speakers 22 may be disposed so as to partially overlap each other.

In the above-described setting of the notification area 51, when the carrying device 1B approaches the end 74 of the platform 72, the notification is capable of being performed to the subject person. With this configuration, the notification system 1 causes the subject person who carries the carrying device 1B to perceive the danger of falling before the subject person falls from the end 74 of the platform 72 to the travel area 78 of the railway vehicle 80.

In the carrying device 1B, the ultrasonic wave detection unit 41 is provided by a microphone that is capable of detecting the sound output from the ultrasonic wave speaker 22. The ultrasonic wave detection unit 41 is preferably capable of detecting the ultrasonic wave, but may be able to detect the audible sound when the sound output from the ultrasonic wave speaker 22 is modulated into the audible sound. The ultrasonic wave detection unit 41 may be provided by a microphone for voice calls.

The notification unit 42 has a known configuration that performs notification to the subject person carrying the carrying device 1B. The notification unit 42 may be provided by a speaker for notification by sound, a light emitting unit for notification by light, a vibration unit for notification by vibration, an odor generation unit for notification by smell, or the like. In particular, in the present embodiment, the notification unit 42 is provided by a vibration unit having a known vibrator.

The processing unit 10 of the sound field generation device 1A and the control unit 30 of the carrying device 1B mainly include a well-known microcomputer respectively having CPUs 11, 31, and a semiconductor memory (hereinafter, referred to as memories 12, 32) such as a RAM, a ROM, or a flash memory. Various functions of the processing unit 10 and the control unit 30 are implemented by executing a program stored in a non-transitory tangible storage medium by the CPUs 11, 31, respectively. In this example, the memories 12, 32 correspond to the non-transitory tangible storage medium that stores the program.

When the program is executed, a method corresponding to the program is executed. The non-transitory tangible storage medium represent storage medium exclusive of electromagnetic waves. The number of microcomputers constituting the processing unit 10 or the control unit 30 may be one or more.

The processing unit 10 of the sound field generation device 1A includes a pattern generation unit 16 and a signal generation unit 17 as functions realized by the CPU 11 executing the program. The control unit 30 of the carrying device 1B includes a filter unit 36, a pattern recognition unit 37, and a notification determination unit 38 as functions realized by the CPU 31 executing the program.

A method for implementing these elements constituting the processing unit 10 and the control unit 30 is not limited to software, and some or all of the elements may be implemented by using one or more hardware elements. For example, when the above functions are implemented by an electronic circuit that is hardware, the electronic circuit may be implemented by a digital circuit that includes a large number of logic circuits, an analog circuit, or a combination of the digital circuit and the analog circuit.

In the processing unit 10 of the sound field generation device 1A, the pattern generation unit 16 generates a signal pattern for outputting a pattern sound. The pattern sound is a sound wave transmitted to the notification area 51 and indicates a sound having a specific pattern.

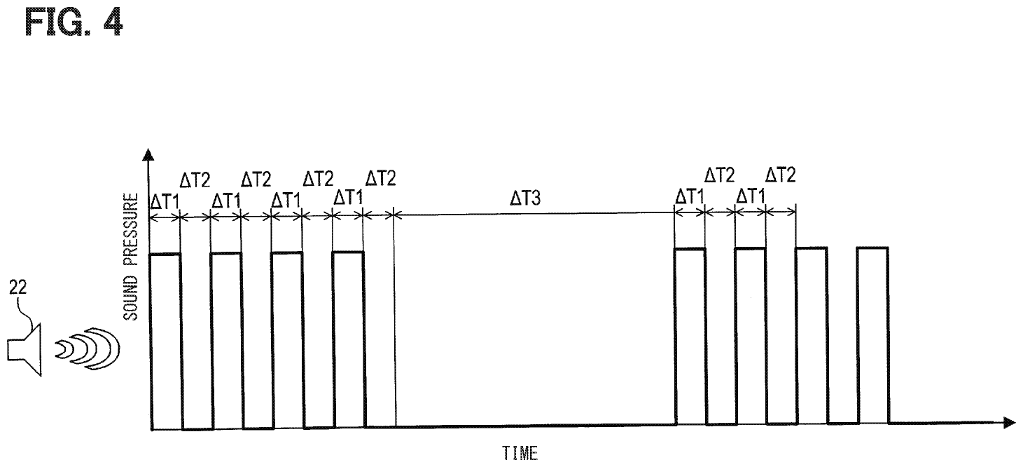

For example, as shown in FIG. 4, the generated signal pattern may be a pattern that continuously repeats a pattern, for four periods, making a sound for a period of ΔT1 and then being soundless for a period of ΔT2, and then a pattern being soundless for a period of ΔT3.

ΔT1 and ΔT2 are arbitrarily set according to the resolution of the ultrasonic wave detection unit 41. For example, ΔT1 and ΔT2 are each set to about 0.8 to 25 ms. ΔT3 is, for example, a time equal to or longer than the sum of ΔT1 and ΔT2, and may be set to about 1.6 to 500 ms.

In the configuration using the ultrasonic wave, since the wavelength is short with respect to the audible sound, even if ΔT1 and ΔT2 are set to a shorter time, it can be easily recognized well.

The signal generation unit 17 modulates the ultrasonic wave to a lower frequency so as to generate the pattern sound, and outputs the sound having directivity to the notification area 51. The signal generation unit 17 generates sound having directivity so as to limit the notification area 51 to an area that is dangerous for the subject person, and to prevent the notification area 51 from spreading in an area that is not dangerous. That is, the notification area 51 is generated with the ultrasonic wave that have a characteristic that the sound pressure increases rapidly when approaching the sound axis.

Specifically, the signal generation unit 17 may perform amplitude modulation to the waveform of the ultrasonic wave with a constant amplitude having a predetermined frequency of about 40 kHz. With this configuration, the signal generation unit 17 generates a waveform of which the amplitude is modulated. In the waveform, the frequency is, for example, about 4 kHz which is detectable by the ultrasonic wave detection unit 41 and the signal pattern is generated by the pattern generation unit 16. In order to generate the waveform, after performing amplitude modulation to the waveform of the ultrasonic wave with a constant amplitude to be a target frequency, the signal generation unit 17 changes the output level so as to coincide the signal pattern.

The control unit 30 of the carrying device 1B executes danger notification processing described later using the functions of the filter unit 36, the pattern recognition unit 37, and the notification determination unit 38.

(1-2. Processing)

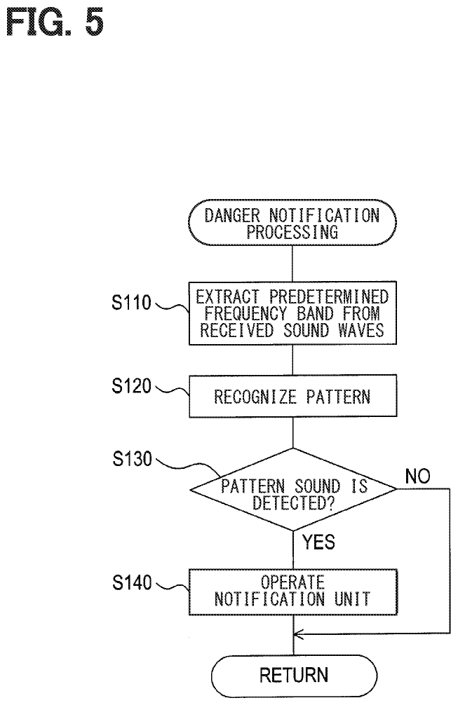

Next, the danger notification processing executed by the control unit 30 of the carrying device 1B will be described with reference to the flowchart of FIG. 5. The danger notification processing is started when a predetermined application related to the danger notification is activated in the carrying device 1B, and then repeatedly executed.

In the danger notification processing, at S110, the control unit 30 uses the function of the filter unit 36 to extract a sound wave having a frequency corresponding to the modulated frequency output from the ultrasonic wave speaker 22 from the sound wave detected by the ultrasonic wave detection unit 41. In this process, the sound wave is analyzed as software processing, and the sound wave having a predetermined frequency band is extracted. This process may be realized using known hardware such as a known bandpass filter.

Subsequently, at S120, the control unit 30 recognizes the pattern sound using the function of the pattern recognition unit 37. The pattern sound is generated by the pattern generation unit 16 and output from the ultrasonic wave speaker 22. In this process, the control unit 30 determines whether the pattern recognition unit 37 detects the sound for the time corresponding to ΔT1 and the silent for equal to or more time corresponding to ΔT2 for N periods from the sound wave having the frequency extracted at S110. When the pattern recognition unit 37 detects the pattern for N periods, the control unit 30 recognizes that the pattern sound is detected. The value of N can be set arbitrarily, but may be set to a value of about 2, for example.

Subsequently, at S130, the control unit 30 determines whether the pattern sound is detected using the function of the notification determination unit 38. At S130, when the control unit 30 determines that the pattern sound is not detected, the control unit 30 determines that the carrying device 1B exists outside the notification area 51 and terminates the danger notification processing.

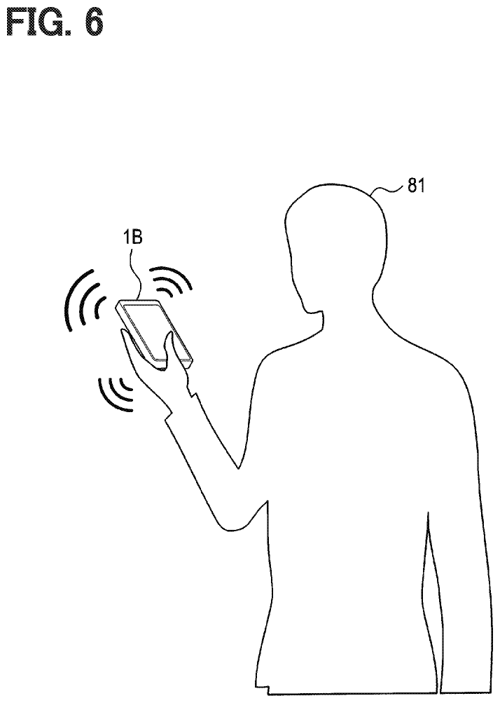

On the other hand, when the pattern sound is detected at S130, the control unit 30 proceeds to S140, and notifies the subject person 81 by vibrating the vibrator constituting the notification unit 42 as shown in FIG. 6.

Since the subject person 81 having the carrying device 1B is notified by the notification unit 42, the subject person 81 can recognize that the subject person 81 is in the notification area 51.

(1-3. Effects)

According to the first embodiment detailed above, the following effects may be obtained.

(1a) In the above-described notification system 1, the control unit 30 of the carrying device 1B detects the pattern sound transmitted by the ultrasonic wave output unit 20. In particular, the pattern sound has directivity. When detecting the pattern sound, the control unit 30 notifies the subject person.

According to such a notification system 1, the notification is performed to the subject person in the notification area 51 formed by the pattern sound. In this configuration, when the area that is not safe is set to be the notification area 51, the notification system 1 can notify the subject person in the unsafe position and reduce a notification to the subject person in the safe position.

(1b) In the notification system 1 described above, the sound field generation device 1A generates the pattern sound using the ultrasonic wave and transmits the pattern sound to the target area via the ultrasonic wave output unit 20. The control unit 30 of the carrying device 1B detects the pattern sound transmitted by the ultrasonic wave output unit 20.

According to such a notification system 1, the pattern sound generated by the sound wave having directivity, for example, the ultrasonic wave is used. With this configuration, the target area can be set to a narrow range, and the carrying device 1B located in the notification area 51 formed by the pattern sound can be perform the notification.

(1c) In the notification system 1 described above, the sound field generation device 1A modulates the ultrasonic wave to a lower frequency to form the notification area 51 with the pattern sound, and transmits the pattern sound to the target area. The control unit 30 of the carrying device 1B detects the pattern sound transmitted by the ultrasonic wave output unit 20.

According to such a notification system 1, the pattern sound is generated using the sound wave in which the ultrasonic wave is modulated to a lower frequency. With this configuration, the notification system 1 can generate the pattern sound that is adapted to the receivable frequency of the sound wave for the carrying device 1B.

(1d) In the notification system 1 described above, the control unit 30 of the carrying device 1B notifies the subject person by vibrating the vibrator constituting the notification unit 42.

According to such a notification system 1, notification is performed by vibration. With this configuration, even when the subject person is a visually handicapped person or when the subject person is located in an area where the environmental sound is large, the notification can be preferably performed.

(1e) In the notification system 1, the processing unit 10 of the sound field generation device 1A includes the pattern generation unit 16 and the signal generation unit 17. In this configuration, the processing unit 10 generates the sound wave signal including the pattern sound that indicates the sound having the specific pattern and directivity. The ultrasonic wave output unit 20 outputs the sound wave based on the sound wave signal to the target area.

According to such a notification system 1, the pattern sound having directivity to the target area is output. With this configuration, when the pattern sound can be detected in the target area, the notification system 1 can notify the subject person that the subject person is located in the target area.

(2. Second Embodiment)

(2-1. Difference from the First Embodiment)

Since the basic configuration of a second embodiment is similar to the first embodiment, the difference will be described below. Note that the same reference numerals as those in the first embodiment indicate the same configuration, and refer to the preceding descriptions.

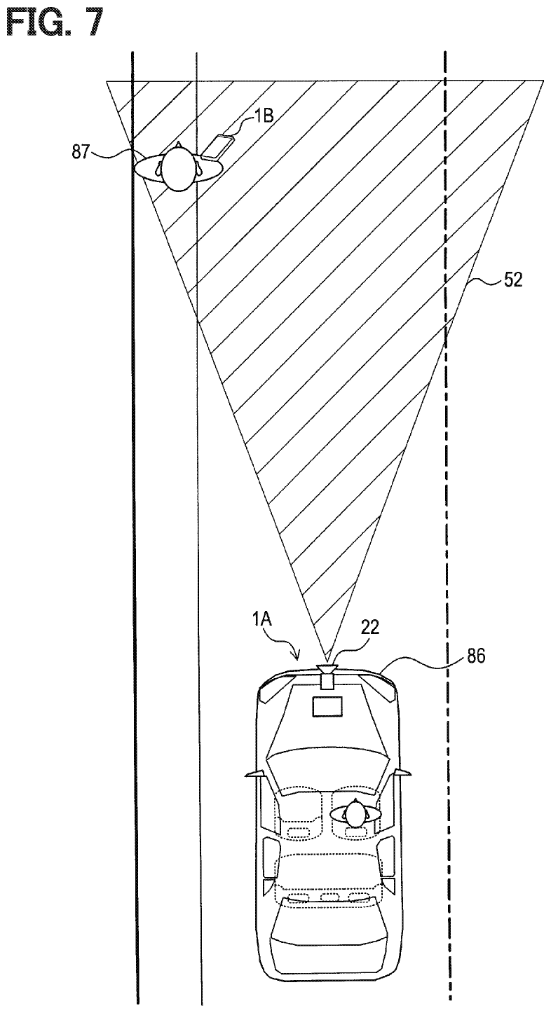

In the notification system 1 of the first embodiment described above, the sound field generation device 1A is disposed on the ceiling 71 of the platform 72, and the target area and the notification area 51 are set at the end of the railway station platform. In a notification system 2 of the second embodiment, as shown in FIG. 7, the sound field generation device 1A is mounted on a vehicle 86, such as a passenger car, traveling on a road, and the target area and the notification area 52 are set on the road.

(2-2. Configuration)

In the notification system 2 of the second embodiment, as shown in FIG. 7, the sound field generation device 1A is attached to the vehicle 86, and the ultrasonic wave speaker 22 is disposed on a surface facing the traveling direction of the vehicle 86. In particular, in the present embodiment, the ultrasonic wave speaker 22 is disposed in the front area of the vehicle 86 and directed forward.

At least one ultrasonic wave speaker 22 may be disposed. The ultrasonic wave speaker 22 may be disposed on the rear area of the vehicle and directed backward. The front ultrasonic wave speaker 22 and the rear ultrasonic wave speaker 22 may be disposed. In this case, the processing unit 10 detects the traveling direction of the vehicle so that one of the ultrasonic wave speakers 22 in the traveling direction of the vehicle operates.

In the configuration of the present embodiment, the target area is set on the road in the traveling direction of the vehicle 86, and the notification area 52 as a sound field generated by the ultrasonic wave speaker 22 is formed so as to coincide with the target area. When the subject person 87 having the carrying device 1B exists in the notification area 52, the notification can be made in the manner similar to the configuration of the first embodiment.

The processing executed by the sound field generation device 1A and the carrying device 1B can employ the processing similar to the notification system 1 of the first embodiment.

(2-3. Effects)

The second embodiment described above provides the effect (1a) according to the above described first embodiment and the following effect.

(2a) In the notification system 2 of the second embodiment, the notification area 52 is formed in the traveling direction of the vehicle 86. With this configuration, the notification system 2 can notify the subject person 87 located on the course of the vehicle 86. Therefore, even when the traveling sound of the vehicle 86 is small, the notification system 2 can preferably notify the subject person 87 that the vehicle 86 is approaching.

(3. Other Embodiments)

Although the embodiments of the present disclosure have been described above, the present disclosure is not limited to the embodiments described above, and various modifications can be made to implement the present disclosure.

(3a) In the above embodiments, the sound wave that changes the intensity of the sound pressure is generated as the pattern sound generated by the sound field generating device 1A, but the pattern sound is not limited thereto. The sound field generation device 1A may generate a pattern sound by changing the sound frequency or a pattern sound by synthesizing sounds having a plurality of frequencies. The sound field generation device 1A may generate a pattern sound that combines factors, such as sound pressure strength, change in sound frequency, synthesis of sounds of a plurality of frequencies, and the like.

(3b) In the above embodiments, the sound field generation device 1A generates the audible pattern sound by the ultrasonic wave modulation. The sound field generation device 1A may generate a pattern sound in an ultrasonic wave range of 20 kHz or higher.

According to such a configuration, since the ultrasonic wave range is a sound range that is difficult to be included in the environmental sound, erroneous detection of the pattern sound can be suppressed.

(3c) A plurality of functions of one element in the above embodiment may be implemented by a plurality of elements, or one function of one element may be implemented by a plurality of elements. Further, a plurality of functions of a plurality of elements may be implemented by one element, or one function implemented by a plurality of elements may be implemented by one element. A part of the configuration of the above embodiment may be omitted. At least a part of the configuration of the above embodiment may be added to or replaced with another configuration of the above embodiment. All modes included in the technical idea identified by the wording described in the claims correspond to embodiments of the present disclosure.

(3d) In addition to the notification system 1 described above, various features such as a device constituting the notification system 1, a program for making the computer function as the notification system 1, a non-transitory tangible storage medium such as a semiconductor memory in which the program is stored, and a notification method may be provided to realize the present disclosure.

(4. Correspondence Relation between the Configuration of the Embodiment and the Configuration of the Present Disclosure)

The sound field generation device 1A of the above-described embodiments corresponds to a sound generation device of the present disclosure. The possessing device 1B of the above-described embodiments corresponds to a notification device of the present disclosure. The pattern generation unit 16 and the signal generation unit 17 of the above-described embodiments correspond to a sound wave generation unit of the present disclosure. The ultrasonic wave output unit 20 of the above-described embodiments corresponds to a sound wave output unit, a sound wave transmission unit, a sound wave transmitter of the present disclosure.

The notification unit 42 of the above-described embodiments corresponds to a vibration unit of the present disclosure. The processes at S110 to S140 executed by the control unit 30 in the above-described embodiments correspond to a notification method of the present disclosure. In particular, the processes at S110 and S120 correspond to a detection unit of the present disclosure. The processes at S130 and S140 correspond to a notification unit of the present disclosure. The control unit 30 in the above-described embodiments correspond to a first processor in the present disclosure. The processing unit in the above-described embodiments correspond to a second processor in the present disclosure.

What is claimed is:

1. A notification method executed by a carrying device that is carried by a subject person, the notification method comprising:
detecting a pattern sound repeatedly transmitted from a sound wave transmission unit to a predetermined target area, the pattern sound having, for one pattern period, a plurality of sound periods in which the sound wave transmission unit makes a sound and a plurality of soundless periods in which the sound wave transmission unit is silent, and
notifying the subject person that the carrying device is located in the target area in response to the detecting of the pattern sound for a plurality of pattern periods.

2. The notification method according to claim 1, wherein,
in the detecting of the pattern sound, the pattern sound is transmitted from the sound wave transmission unit attached to a front area of a vehicle and directed forward or attached to a rear area of the vehicle and directed backward.

3. A notification method executed by a carrying device that is carried by a subject person, the notification method comprising:
detecting a pattern sound that indicates a sound having a specific pattern and is transmitted, to a predetermined target area set above a platform of a railway station, from a sound wave transmission unit attached to a ceiling of the platform; and
notifying the subject person that the carrying device is located in the target area in response to the detecting of the pattern sound.

4. The notification method according to claim 3, wherein:
the target area is at an end of the platform closer to an area in which a railway vehicle travels; and
in the detecting of the pattern sound, the pattern sound is transmitted from a plurality of sound wave transmission units, the plurality of sound wave transmission units are arranged on the ceiling of the platform along a direction to which the railway vehicle travels.

5. The notification method according to claim 1, wherein,
in the detecting of the pattern sound, the pattern sound is generated from a ultrasonic wave.

6. The notification method according to claim 5, wherein,
in the detecting of the pattern sound, the pattern sound is generated from the ultrasonic wave that is modulated to a low frequency.

7. The notification method according to claim 1, wherein,
in the notifying to the subject person, the subject person is notified by a vibration of a vibration unit.

8. A notification device carried by a subject person, the notification device comprising a first processor configured to:
detect a pattern sound repeatedly transmitted from a sound wave transmission unit to a predetermined target area, the pattern sound having, for one pattern period, a plurality of sound periods in which the sound wave transmission unit makes a sound and a plurality of soundless periods in which the sound wave transmission unit is silent; and
notify the subject person that the subject person is located in the target area when the pattern sound is detected for a plurality of pattern periods.

9. A notification device carried by a subject person, the notification device comprising a first processor configured to:
detect a pattern sound transmitted, to a predetermined target area set above a platform of a railway station, from a sound wave transmission unit attached to a ceiling of the platform, the pattern sound indicative of a sound having a specific pattern; and
notify the subject person that the subject person is located in the target area when the pattern sound is detected.

10. A sound generation device comprising:
a second processor configured to repeatedly generate a sound wave signal having a pattern sound; and
a sound wave transmitter configured to output a sound wave based on the sound wave signal to a predetermined target area and a carrying device (i) located in the target area, (ii) carried by a subject person, and (iii) configured to notify the subject person when the carrying device detects the pattern sound, wherein
the pattern sound has, for one pattern period, a plurality of sound periods in which the sound wave transmitter makes a sound and a plurality of soundless periods in which the sound wave transmitter is silent.

11. A sound generation device comprising:
a second processor configured to generate a sound wave signal having a pattern sound that indicates a sound having a specific pattern; and
a sound wave transmitter attached to a ceiling of a platform of a railway station and configured to output a sound wave based on the sound wave signal to a predetermined target area set above the platform and a carrying device (i) located in the target area, (ii) carried by a subject person, and (iii) configured to notify the subject person when the carrying device detects the pattern sound.
